(19) United States
(12) Patent Application Publication
(10) Pub. No.: US 2004/0066874 A1
(43) Pub. Date: Apr. 8, 2004

(54) Method for forming coatings on structural components with corrosion-mitigating materials

(76) Inventors: Young Jin Kim, Clifton Park, NY (US); Dennis Michael Gray, Delanson, NY (US); Peter Louis Andresen, Schenectady, NY (US); Eric Moran, Schenectady, NY (US)

Correspondence Address: General Electric Company, CRD Patent Docket Rm 4A59, M.N. Salamone, P.O. Box 8, Bldg. K-1, Schenectady, NY, 12301, US

(21) Appl. No.: 10/653,184

(22) Filed: Sep. 3, 2003

Related U.S. Application Data
(62) Division of application No. 10/064,625, filed on Jul. 31, 2002.

(51) Int. Cl. G21C 9/00

(52) U.S. Cl. 376/305

(57) ABSTRACT

A method for mitigating crack initiation and propagation on a surface of a metal component due to susceptibility to corrosion comprises depositing a metallic material on the surface of the component to form a coating, and then converting at least an outer layer of the coating to an electrically insulating material. The deposition of the metallic material is carried out by a method selected from the group consisting of wire-arc spraying, physical vapor deposition, and chemical vapor deposition. Electrochemical corrosion potential less than −0.23 V_{SHE} based on the standard hydrogen electrode can be achieved with the method of coating of the present invention. This method is applied to produce coated structural components of water-cooled nuclear reactor.

### BACKGROUND OF THE INVENTION

The present invention relates to a method for forming coatings of protective materials comprising metals or metallic compounds on structural components, which coatings substantially mitigate corrosion of the underlying materials of the components. In particular, the present invention relates to such a method for forming coatings on components used in nuclear water-cooled reactors.

Many metallic structural materials are susceptible to corrosion when exposed to water at high temperatures, such as greater than about 100° C., especially when the water contains dissolved oxygen or other compounds that can produce oxygen. Examples of these structural materials are carbon steel, alloy steel, stainless steel, nickel-based, cobalt-based, and zirconium-based alloys, which materials have been used in nuclear reactors, wherein they are exposed to high-temperature water containing appreciable amounts of dissolved oxygen and hydrogen peroxide. For example, the dissolved oxygen concentration in the water outside the core of a boiling water reactor (“BWR”) can be about 200 parts per billion (“ppb”) or higher. The concentration of hydrogen peroxide in the recirculation water of a BWR can be on the same order of magnitude. Such corrosion contributes to a variety of problems; e.g., stress corrosion cracking, crevice corrosion, erosion corrosion, sticking of pressure relief valves, etc.

Stress corrosion cracking (“SCC”) is a known phenomenon occurring in reactor components, such as structural members, piping, fasteners, and welds, which are exposed to high temperatures. As used herein, SCC refers to cracking propagated by static or dynamic tensile stressing in combination with corrosion at the crack tip. The reactor components are subject to a variety of stresses associated with, for example, differences in thermal expansion, the operating pressure required for the containment of the cooling water, and other sources such as residual stress from welding, cold working, and other asymmetric metal treatments. Operating temperatures and pressure for a BWR are typically about 288° C. and about 7 MPa; and those for a pressurized water reactor (“PWR”) are about 320° C. and about 15 MPa. Thus, the chance for SCC in reactor components is heightened. In addition, water chemistry, crevice geometry, heat treatment, and radiation can increase the susceptibility of the metal in a component to SCC.

SCC occurs at higher rates when oxidizing species are present in the reactor water. SCC is further increased in a high radiation flux where oxidizing species, such as oxygen, hydrogen peroxide, and short-lived radicals, are produced from radiolytic decomposition of the reactor water. Such oxidizing species increase the electrochemical corrosion potential (“ECP”) of metals. Electrochemical corrosion begins with a flow of electrons across an interface between a metal and a medium in contact therewith. The ECP is a measure of the thermodynamic tendency for corrosion phenomena to occur, and is a fundamental parameter in determining rates of, e.g., SCC, corrosion fatigue, corrosion film thickening, and general corrosion. Corrosion potential has been shown to be a primary variable in controlling the susceptibility of metal to SCC in BWR environments. U.S. Pat. Nos. 5,164,152; 5,465,281; 5,774,516; and 5,793,830; the contents of which are incorporated herein by reference, discuss in detail the chemistry of corrosion at interfaces.

Three methods have been disclosed for the mitigation of the potential for corrosion of BWR structural components. In the first method, which employs “hydrogen water chemistry” (“HWC”), hydrogen is injected into the reactor feedwater so as to react with radiolytically produced oxidizing species in a homogeneous reaction in the reactor vessel. The rate of depletion of oxidizing species in this scheme is dependent on local radiation fields and convectional and diffusional variables. In order to ensure that the ECP is maintained below the “critical potential” level of about −0.23 V based on the standard hydrogen electrode (“SHE”) scale, hydrogen concentration of about 200 ppb or greater must be provided. The use of a large amount of hydrogen brings a safety concern and an associated high radiation level in the steam-driven turbine section of the plant. Therefore, in order to lower the required concentration of hydrogen, the second method provides coatings on the reactor components, which coatings comprise a small amount of palladium or other noble metals that act as catalysts for the reaction of hydrogen and oxidizing species. However, an excess amount of hydrogen is required to get the SCC protection potential. The third method employs a coating of an electrically insulating material on the reactor component. The term “electrically insulating,” as used herein, means more electrically insulating than an oxide of the metallic reactor component. Materials, such as zirconia, yttria-stabilized zirconia, alumina, and zinc oxide, have been proposed in U.S. Pat. No. 5,465,281. However, a successful deposition of these materials requires a good adhesion to the substrates. U.S. Pat. No. 5,793,830 discloses a plasma deposition of a metal alloy coating on the component and a subsequent self-passivation of the metal alloy to form an electrically insulating layer. The metal alloy is delivered as a powder into the anode nozzle downstream from the arc root. Particle size distribution is very important because it affects injection velocity, momentum transfer, heat transfer, and heat needed to melt and superheat the particles. Even with a very tight particle size distribution, the injection velocity can have a broad range. Although improvements in equipment design have been proposed and implemented, plasma spraying still can result in variability in the quality of the coating.

Therefore, there is a continued need to provide structural components that are less susceptible to corrosion cracking. It is also desirable to provide a simple method for making such components, which method is less susceptible to variability.

### BRIEF SUMMARY OF THE INVENTION

The present invention provides a method for mitigating corrosion cracking on a structural component by depositing a coating on a component. The method comprises depositing a coating material onto a surface of the component by a method selected from the group consisting of wire-arc spraying, physical vapor deposition, and chemical vapor deposition.

In one aspect of the present invention, a metallic precursor of the desired coating material is provided as wires for the wire-arc spraying. The structural component with a layer of the metallic coating precursor is subsequently self-passivated to form at least an outer layer of a substantially electrically insulating material on the component.

In another aspect of the present invention, the coating material or its precursor is carried in the form of liquid droplets by a plasma toward the component to be coated. The liquid droplets are formed by melting the material at the wire ends by the arc.

In still another aspect of the present invention, the component on which the coating is formed is a structural component of a nuclear power plant that has a water-cooled nuclear reactor, and the structural component is in contact with hot water containing radiolytically produced oxidizing species.

Other features and advantages of the present invention will be apparent from a perusal of the following detailed description of the invention and the accompanying drawings in which the same numerals refer to like elements.

### BRIEF DESCRIPTION OF THE DRAWINGS

FIG. 1 is a schematic diagram of electrochemical processes which generally lead to elevated corrosion potential on the outside (mouth) of a crack and low corrosion potential in the inside (tip) of the crack.

FIGS. 2A to 2F provides a schematic comparison of the corrosion potentials Φ_{c}, which form under high radiation flux on various coated and uncoated components.

FIG. 3 shows the corrosion potential of Type-304 stainless steel uncoated and coated with yttria-stabilized zirconia by air plasma spraying as a function of dissolved oxygen concentration.

FIGS. 4A to 4C are schematic illustrations of a protective metal alloy coating having an insulating layer, wherein the coating is formed by a wire-arc spraying process.

FIG. 5 schematically shows a wire-arc spraying gun head.

FIG. 6 compares the ECPs of various coated and uncoated metal substrates.

### DETAILED DESCRIPTION OF THE INVENTION

The present invention provides a simple method for mitigating SCC on structural components; for example, those in contact with hot water in a water-cooled nuclear reactor. The method comprises depositing a coating on a structural component, which coating is or becomes electrically insulating; e.g., by self-passivation, prior to or within about a month after the component is exposed to a medium containing oxidizing species. The terms “electrically insulating” means more electrically insulating than an oxide of the underlying material of the structural component. Only a layer of the coating needs to become electrically insulating in order to provide the protection realized in the present invention. Self-passivation refers to a process by which a thin protective film is formed on a surface of a metallic component when it is exposed to a medium containing at least a reactive species, such as an oxidizing species. Metals, such as chromium, aluminum, silicon, scandium, yttrium, lanthanum, titanium, zirconium, hafnium, vanadium, niobium, tantalum, cerium, and alloys thereof can readily form such protective films.

The method of the present invention achieves low ECPs in an oxidizing medium. For example, such a medium exists in the high-flux in-core region of a water-cooled nuclear reactor or in other regions that may have very high supply rates of oxidizing species due to high concentrations of these species and/or high fluid flow rates or convection. Low ECPs, such as less than about −0.23 V_{SHE}, are achieved by forming a coating of an electrically insulating material on a surface of a metallic component that is susceptible to SCC using the wire-arc spraying technique. In a BWR, structural components are typically made of various types of stainless steel, the SCC potential of which can be effectively reduced by an electrically insulating coating produced by the method of the present invention. A metal or metal alloy may be wire-arc sprayed on the surface of the metallic component, and the metal or metal alloy is self-passivated to become electrically insulating. Alternatively, an electrically insulating ceramic material may be wire-arc sprayed on the surface of the metallic component. A plasma can be provided to the wire-arc spraying apparatus facilitate the spraying of higher-melting ceramics.

In another embodiment of the present invention, one or more metals are deposited on the surface of the structural component by physical vapor deposition, such as evaporation, glow-discharge sputtering, or magnetron-based sputtering. These processes are described in more detail in L. V. Interrante and M. J. Hampden-Smith (ed.), “Chemistry of Advanced Materials,” pp. 175-180, Wiley-VCH, New York (1998). This information is incorporated herein by reference.

In still another embodiment of the present invention, an electrically insulating material is deposited on the surface of the structural component by chemical vapor deposition. A combination of the reactant or reactants and the background atmosphere can be chosen to produce a deposited metallic coating, a top layer of which is thereafter converted to an electrically insulating material. For example, metals hydrides, metal alkyls, or organometallic complexes in an inert atmosphere, such as argon or helium, or a mixture of an inert gas and a reducing gas, can produce a deposited metallic film. Alternatively, an electrically insulating material can be deposited directly on the surface by an appropriate choice of reactants. For example, metal halides, metal alkyls, organometallic complexes, or mixtures thereof, in an oxidizing atmosphere can produce oxide films, which can be electrically insulating. Carbide films may be deposited from metal hydrides, metal alkyls, metal halides in an atmosphere containing an inert ags, hydrogen, a hydrocarbon, or a mixture thereof. Nitride films may be deposited from these precursors in an atmosphere containing ammonia, nitrogen, or a mixture thereof. Boride films may be deposited from these precursors in an atmosphere containing, for example, borane, boron halides, or boron organohalide.

ECPs are created at an interface of a metal and an adjacent medium containing oxidizing species. Thus, while on a metal coating the ECP is formed at the interface of the metal coating with the bulk water of the reactor, on an insulating coating, the ECP is formed at the interface of the substrate metal and the water with which it is in contact (i.e., the water in the pores, cracks, or crevices, as described herein).

The influence of corrosion potential on stress corrosion cracking results from the difference in corrosion potential at the generally high potential crack mouth/free surface versus the always low potential (e.g., −0.5 V_{SHE}) within the crack/crevice tip. This potential difference causes electron flow in the metal and ionic flow in the solution, which induces an increase in the anion concentration in the crack, as in a classical crevice.

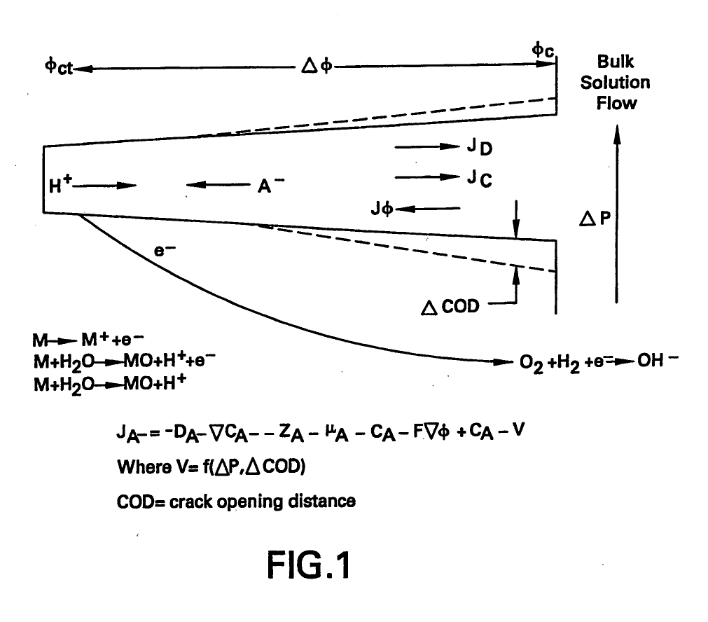

FIG. 1 is a schematic of electrochemical processes which generally lead to elevated corrosion potentials on the outside (mouth) of a crack and low corrosion potentials in the inside (tip) of the crack. The potential difference ΔΦ_{c} causes anions A⁻ (e.g., Cl⁻) to concentrate in the crack, but only if there is both an ionic path and an electron path.

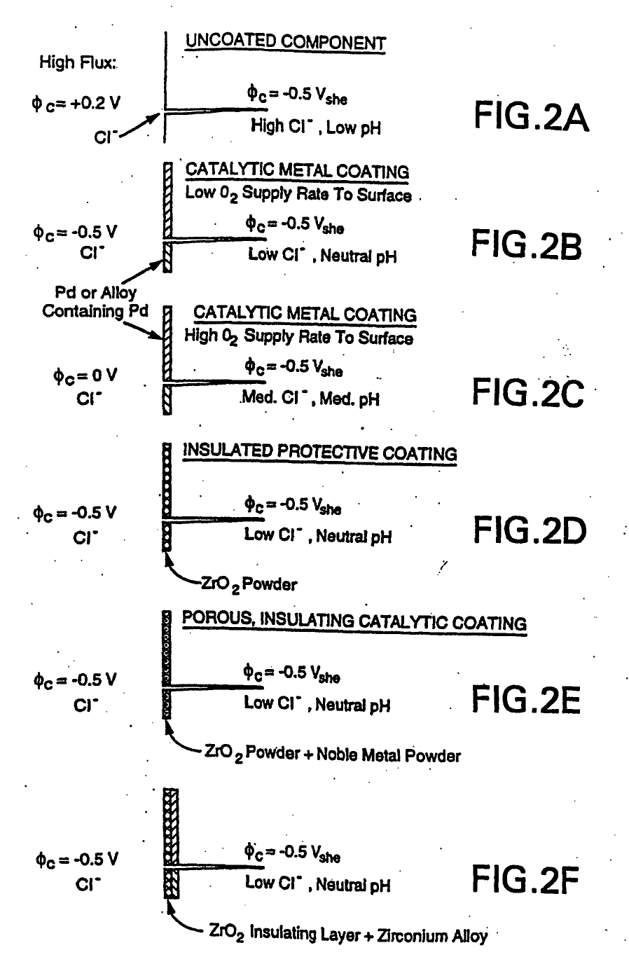

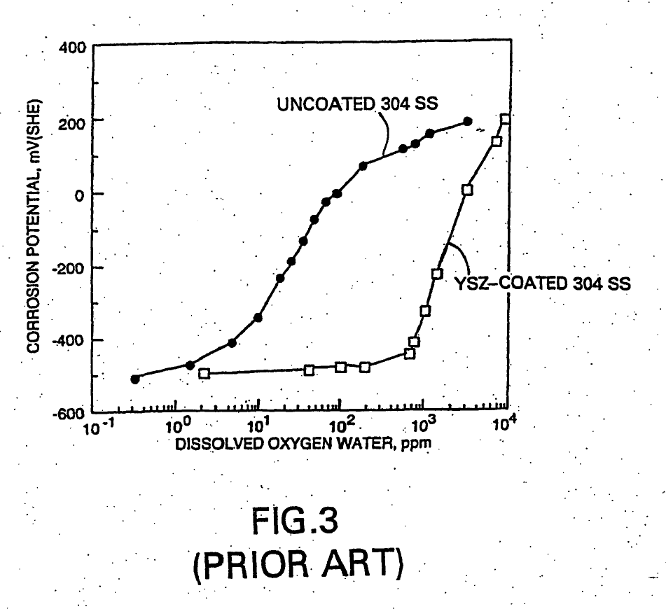

FIGS. 2A to 2F provide a schematic comparison of the corrosion potentials Φ_{c} which form under high radiation flux: (A) on an uncoated (e.g., stainless steel) component (high Φ_{c}); (B) on a component coated with a catalytic metal coating where the rate of supply of reactants to the surface is not too rapid (low Φ_{c}); (C) on a component coated with a catalytic metal coating where the rate of supply of reactants to the surface approaches or exceeds the recombination kinetics for H₂ and O₂ (moderate Φ_{c}); (D) on a component coated with an insulated protective coating (at a low corrosion potential provided that oxidant concentrations do not get too high, see FIG. 3); (E) on a component coated with an insulated protective coating that is doped with a noble metal (always at a low corrosion potential); and (F) on a component coated with a metal alloy coating having an insulating layer on an outer surface (always at a low corrosion potential).

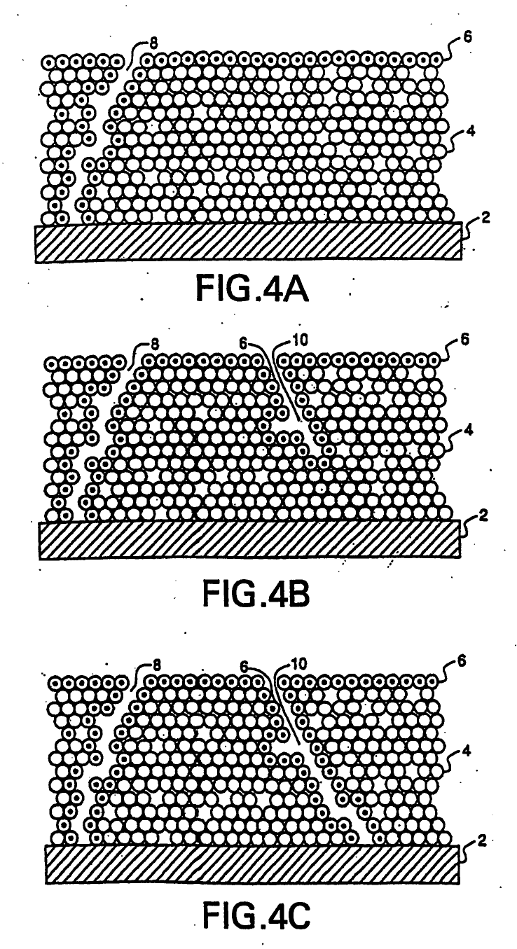

Thus, to influence stress corrosion cracking, the elevated crack mouth corrosion potential must form on a surface that is in electrical contact with the component of interest. If a metal alloy coating having an insulating layer coating (see FIGS. 2 and 4) were applied to a metal component and some porosity, cracks or crevices in the coating are assumed to exist, the corrosion potential would be formed only at the metal component-water interface, so long as the metal alloy forms an insulating layer within the crack when it is formed or as it advances through the coating.

Thus, a crevice could be present in the coating, but since it is electrically insulating, the crevice cannot represent an “electrochemical” crevice, but only a “restricted mass transport” geometry. The critical ingredient in “electrochemical” crevices is the presence of a conducting material in simultaneous contact with regions of high potential (e.g., a crack mouth) and regions of low potential (e.g., a crack tip). Thus, it would not help to have a component covered by a metal alloy layer (or interconnected metal particles) within which exists a series of interconnected pores, a crevice or crack, if an insulating layer is not formed within the interconnected pores, crack or crevice. Under these conditions, the aggressive crevice chemistry could form in the metal alloy layer, which in turn would be in contact with the component.

Therefore, metal or metal alloy coatings of this invention are characterized by being insulating, adherent, and insoluble in high temperature water. Insulating in this context means more insulating than the oxides that form on metal components used to contain high-temperature water, which are typically Fe-based, Ni-based and Co-based alloys, particularly stainless steels. These alloys form semi-conducting surface oxides that are known to be susceptible to electron transport through them. The electrical conductivity characteristics of the insulating layers formed on the metal alloys of this invention should be significantly lower than the outer oxide layer of the metal component, preferably at least two orders of magnitude lower, and more if possible. The insulating layer must be adherent, and thus not subject to spallation due to thermal cycling conditions that are typically experienced in high-temperature water systems. Finally, the insulating layer must be insoluble in high-temperature water, particularly when the water contains oxidizing species such as dissolved oxygen and/or hydrogen peroxide.

Another consideration is that if the insulating coating is impermeable to water, there can be neither a corrosion potential formed on the underlying metal, nor concern for stress corrosion cracking. Any pores, fine cracks or crevices in an insulating layer provide highly restricted mass transport and thus are equivalent to a very thick near-surface boundary layer of stagnant water. Since oxidants (or oxidizing species) are always being consumed at metal surfaces, this very restricted mass transport, which results in a reduced rate of oxidant supply, causes the arrival rate of oxidants through the insulating coating to the substrate to decrease below the rate of their consumption. Under these mass transport-limiting circumstances, the corrosion potential rapidly decreases to values≦−0.5 V_{SHE}, even for high bulk oxidant concentrations, and even in the absence of stoichiometric excess hydrogen (or any hydrogen). Numerous observations consistent with this have been made, including low potentials on stainless steel surfaces at low oxygen levels (e.g., 1 to 10 ppb), as well as in (just inside) crevices/cracks, even at very high bulk oxygen levels.

Thus, corrosion potentials ≦−0.5 V_{SHE} can be achieved using metal alloy coatings of the present invention, even at high bulk oxidant concentrations and, not only in the absence of stoichiometric excess hydrogen, but also in the absence of any hydrogen. This may prove to be a critical invention for BWR plants which are unable (because of cost or because of the high ¹⁶N radiation levels from hydrogen addition) to add sufficient hydrogen to guarantee stoichiometric excess hydrogen conditions at all locations in their plant.

Metal alloys of the present invention may comprise any alloy that will self-passivate by forming an oxide in high-temperature water or air that meet the criteria described herein concerning the insulating layer. Self- or spontaneous passivation is important because it is believed that small pores, cracks or crevices will occur in most metal alloy coatings, either immediately upon their deposition, or after a short exposure in a high-temperature water environment. These pores, cracks or crevices must form an insulating layer as described herein, otherwise they would be a potential source for crevice corrosion as described herein. Potentially suitable materials for forming coatings comprise metals or metal alloys selected from the group consisting of Al, Cr, Si, Sc, Y, La, Ti, Zr, Hf, V, Nb, Ta, Ce, and alloys thereof. Zirconium-based alloys, such as Zircaloy-2 or Zircaloy-4, are especially suitable for nuclear reactor applications because of their known compatibility in nuclear reactor systems. Zircaloy-2 contains 1.2-1.7 weight percent tin, 0.07-0.2 weight percent iron, 0.05-0.15 weight percent chromium, 0.03-0.08 weight percent nickel, 0.09-0.15 weight percent oxygen, and the balance being zirconium, wherein the combined amount of iron, chromium, and nickel is in the range of 0.16-1.7 weight percent. Zircaloy-4 contains 1.2-1.7 weight percent tin, 0.18-0.24 weight percent iron, 0.07-0.13 weight percent chromium, less than 0.07 weight percent nickel, 0.09-0.15 weight percent oxygen, and the balance being zirconium, wherein the combined amount of iron and chromium is in the range of 0.24-0.28 weight percent.

Various insulating layers may be formed on these metal alloy coatings, but Applicants believe that oxides, carbides, nitrides and borides of these alloys are most compatible with high-temperature water applications. In the case of zirconium-based alloys, the insulating layer could be an oxide of the alloy, which would comprise zirconia. Zirconia (ZrO₂) is a good initial choice because it forms spontaneously in air or water, and it also may be applied by thermal spraying. Zirconia is also very stable in high-temperature water, both structurally (e.g., it is not prone to spalling and is not susceptible to environmentally assisted cracking) and chemically (e.g., it does not dissolve or react). Zirconia can also be obtained in various particle sizes, so that there is flexibility in adjusting the thermal spray parameters, where thermal spraying is the desired method of forming the insulating layer. Alumina is also an option. The dissolution rate of alumina in 288° C. water is higher than that for zirconia, but is still very low. Various other metal oxides, carbides, nitrides or borides may also be suitable, so long as they are mechanically and chemically stable in a high-temperature water environment, including not being subject to dissolution in high-temperature water and not being subject to spalling under the normal operating condition of the high-temperature water system. It should be noted that the insulating layer formed on the surface of the metal alloy coating may not be the same insulating layer (e.g. an oxide) that will form in pores, cracks or crevices as they are exposed to air or water.

FIG. 4A is a schematic illustration of a metal alloy coating of the present invention having an insulating layer, depicted as particles 4 of zirconium, which have been wire-arc sprayed onto metal component surface 2. The particles at the surface are oxidized particles 6, which may be oxidized as described herein, and thus comprise the insulating layer. Although particles 4 and 6 are shown schematically in FIGS. 4A-4C as spherical particles, it should be understood that in reality the shape of any one particle is not necessarily spherical. Crack 8 existing immediately after deposition is also shown. This crack also has oxidized particles 6 on the crack surface upon exposure to an oxidizing environment. Due to the insulating nature of zirconia, there is no electrical connection between external (high oxidant) water and metal component substrate 2. Thus, the insulating layer prevents an electrochemical crevice cell from being formed (see FIG. 1). FIGS. 4B and 4C illustrate how a crack or crevice may progress through the metal alloy coating. As the crack/crevice tip is opened in the presence of an oxidant (e.g. high-temperature water with dissolved oxygen or air) the particles 4 form oxidized particles 6 such that the crack is self-passivating until it reaches the metal substrate 2 (FIG. 4C). Upon reaching metal substrate 2, the crack or crevice 10 restricts the mass transport of oxidants to the underlying metal substrate 2 to sufficiently low rates such that the corrosion potential of the metal component is always low (i.e., −0.5 V_{SHE}).

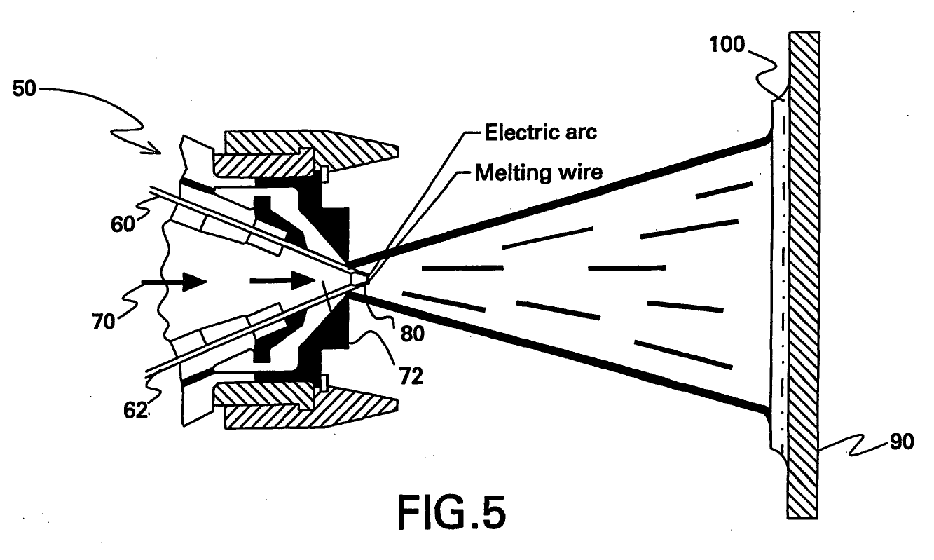

Wire-arc spraying is a method of forming a stream of atomized droplets of a molten material that are accelerated by a gas stream toward and deposited on a substrate. FIG. 5 schematically shows a spray head 50 of a wire-arc spraying gun. In the standard wire-arc spray process, two consumable wires 60 and 62, each connected to an electrical potential and, thus, acting as the arc electrodes, are advanced nearly to meet at a point in an atomizing gas stream 70. The potential difference between the nearly contacting wires generates an arc, which melts the wire tips. A nozzle 72 directs the atomizing gas across the arc zone 80, forming the liquid droplets, propelling them to the substrate 100, and depositing them as a coating 100 thereon. Wire-arc spraying can provide a deposition rate up to about 50 kg/hour. It is desirable to use an inert gas, such as helium, argon, krypton, or xenon, to atomize the liquid metal or metal alloy to form a corrosion-mitigating coating of the present invention. The process of making a coating according to the present invention provides several advantages. The process can use a metal or metal alloy as a precursor for the electrically insulating layer. Such a metal or metal alloy is more compatible with the substrate material and, thus, can result in a better adherence of the coating to the substrate. In addition, a metal or metal alloy can be deposited at a lower temperature than insulating materials due to its lower melting point. Since only an electrically insulating layer is required to protect the structural component, the coating need not be formed entirely of electrically insulating materials, which are typically more difficult to deposit.

In another embodiment, the atomizing gas can be converted into a plasma to provides further thermal energy to the droplets, thus, reducing the likelihood for forming a solidified shell around the droplet, and facilitating the formation of a smooth coating having fewer defects.

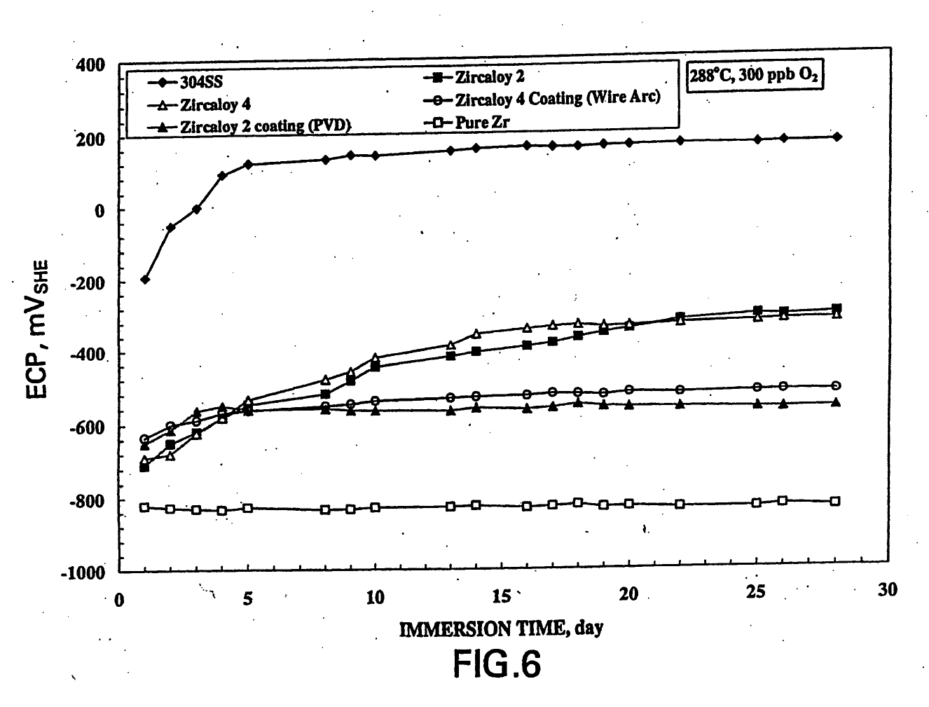

A specimen of Type-304 stainless steel coated with Zircaloy 4 by the wire-arc process was made and tested for ECP in water having about 300 ppb dissolved oxygen at 288° C. over a period of 28 days. It is expected that a film of electrically insulating zirconia is rapidly formed on the Zircaloy-4 coating to provide excellent protection against corrosion of an otherwise corrosion-prone Type-304 stainless steel. Although the test was done with dissolved oxygen concentration of about 300 ppb, a lower concentration, such as about 200 ppb, as is typically encountered in a water outside the core of a BWR, is also expected to easily convert an outer layer of the Zircaloy-4 coating to zirconia. FIG. 6 compares ECPs measured for various metals and coated metals. The specimen made by the wire-arc process shows a more stable and lower ECP (less than −0.5 V_{SHE}) than those of pure Zircaloy 2 and Zircaloy 4. Thus, coatings of electrically insulating materials could be advantageously formed by the wire-arc process on structural components of BWR to mitigate the potential for SCC.

Metal or metal alloy coatings of the present invention may be of any suitable thickness. However, they are expected to be on the order of 0.5 mm or less for most applications. The insulating layer formed on the metal or metal alloy coating can be much thinner; for example, on the order of 1 micron so long as low ECP, such as less than −0.25 V_{SHE}, is achieved.

While various embodiments are described herein, it will be appreciated from the specification that various combinations of elements, variations, equivalents, or improvements therein may be made by those skilled in the art, and are still within the scope of the invention as defined in the appended claims.

What is claimed is:

1. A method for mitigating corrosion cracking on a structural component, said method comprising forming a coating comprising an electrically insulating material on a surface of said structural component.

2. A method for mitigating corrosion cracking on a structural component, said method comprising:
depositing a metallic material on said structural component to form a coating thereon, said depositing being carried out by a method selected from the group consisting of wire-arc spraying, chemical vapor deposition, and physical vapor deposition; and
converting at least an outer layer of said coating to an electrically insulating material that is capable of mitigating corrosion cracking.

3. The method of claim 2, wherein an electrochemical potential (“ECP”) of said structural component coated with said coating is less than about −0.23 V_{SHE} based on a standard hydrogen electrode scale, after said electrically insulating material has been formed on said coating.

4. The method of claim 2, wherein an ECP of said structural component coated with said coating is less than about −0.3 V_{SHE} based on a standard hydrogen electrode scale, after said electrically insulating material has been formed on said coating.

5. The method of claim 2, wherein an ECP of said structural component coated with said coating is less than about −0.5 V_{SHE} based on a standard hydrogen electrode scale, after said electrically insulating material has been formed on said coating.

6. The method of claim 2, wherein said metallic material is selected from the group consisting of aluminum, chromium, silicon, scandium, yttrium, lanthanum, titanium, zirconium, hafnium, vanadium, niobium, tantalum, cerium, and alloys thereof.

7. The method of claim 2, wherein said metallic material is selected from the group consisting of alloys that comprise zirconium, tin, iron, chromium, nickel, and oxygen.

8. The method of claim 2, wherein said converting occurs in less than about a month after said structural component is exposed to an oxidizing species.

9. The method of claim 2, wherein said converting occurs spontaneously when said structural component is exposed to an oxidizing species.

10. The method of claim 2, wherein said converting comprises an oxidation.

11. The method of claim 10, wherein said oxidation takes place when said structural component having said coating is exposed to a water having a material selected from the group consisting of oxygen, hydrogen peroxide, and mixtures thereof, dissolved therein.

12. The method of claim 11, wherein a concentration of said dissolved oxygen is about 200 ppb.

13. The method of claim 11, wherein a concentration of said dissolved oxygen is about 300 ppb.

14. The method of claim 11, wherein a concentration of said dissolved hydrogen peroxide is about 200 ppb.

15. The method of claim 2, wherein said electrically insulating material comprises a material selected from the group consisting of oxide, carbide, nitride, boride, and mixtures thereof.

16. The method of claim 2, further comprising providing a plasma to carry said metallic material to said structural component.

17. The method of claim 2, wherein said structural component is made of a material, an oxide of which has a higher ECP than that of said electrically insulating material.

18. The method of claim 2, wherein said structural component is made of an alloy selected from the group consisting of iron-based, nickel-based, and cobalt-based alloys.

19. A method for mitigating corrosion cracking on a structural component, said method comprising:
wire-arc spraying a metallic material on a surface of said structural component to form a coating thereon, said metallic material being carried to said surface by a stream of atomizing gas; and
converting at least an outer layer of said coating to an electrically insulating material that is capable of mitigating corrosion cracking, said structural component with said electrically insulating outer layer having an ECP less than about −0.23 V_{SHE};
wherein said metallic material comprises a material selected from the group consisting of aluminum, chromium, silicon, scandium, yttrium, lanthanum, titanium, zirconium, hafnium, vanadium, niobium, tantalum, cerium, and alloys thereof; and said converting comprises oxidizing said outer layer to an oxide by exposing said structural component having said coating to a water having an oxidizing species selected from the group consisting of dissolved oxygen, dissolved hydrogen peroxide, and mixtures thereof.

20. A method for mitigating corrosion cracking on a structural component, said method comprising:
depositing by physical vapor deposition a metallic material on a surface of said structural component to form a coating thereon, said metallic material being carried to said surface by a stream of atomizing gas; and
converting at least an outer layer of said coating to an electrically insulating material that is capable of mitigating corrosion cracking, said structural component with said electrically insulating outer layer having an ECP less than about −0.23 V_{SHE};
wherein said metallic material comprises a material selected from the group consisting of aluminum, chromium, silicon, scandium, yttrium, lanthanum, titanium, zirconium, hafnium, vanadium, niobium, tantalum, cerium, and alloys thereof; and said converting comprises oxidizing said outer layer to an oxide by exposing said structural component having said coating to a water having an oxidizing species selected from the group consisting of dissolved oxygen, dissolved hydrogen peroxide, and mixtures thereof.

21. A method for mitigating corrosion cracking on a structural component, said method comprising:
depositing by chemical vapor deposition an metallic material on a surface of said structural component to form a coating thereon; and
converting at least an outer layer of said coating to an electrically insulating material that is capable of mitigating corrosion cracking, said structural component with said electrically insulating outer layer having an ECP less than about −0.23 V_{SHE};
wherein said metallic material comprises a material selected from the group consisting of aluminum, chromium, silicon, scandium, yttrium, lanthanum, titanium, zirconium, hafnium, vanadium, niobium, tantalum, cerium, and alloys thereof; and said converting resulting in a compound selected from the group consisting of oxides, carbides, nitrides, borides, and mixtures thereof.

22. A method for mitigating corrosion cracking on a structural component, said method comprising:
depositing by chemical vapor deposition an electrically insulating material on a surface of said structural component to form a coating thereon, said electrically insulating material being selected from the group consisting of oxides, carbides, nitride, borides, and mixtures thereof; said electrically insulating material being capable of mitigating corrosion cracking, said structural component with said electrically insulating outer layer having an ECP less than about −0.23 V_{SHE};
wherein said electrically insulating material comprises at least a material selected from the group consisting of aluminum, chromium, silicon, scandium, yttrium, lanthanum, titanium, zirconium, hafnium, vanadium, niobium, tantalum, cerium, and alloys thereof.

23. A structural component of a water-cooled nuclear reactor or associated equipment, said structural component comprising:
a metal substrate having a surface which has a corrosion potential and is susceptible to stress corrosion cracking in water having a concentration of a dissolved oxidizing species greater than about 200 ppb, said oxidizing species being selected from the group consisting of oxygen, hydrogen peroxide, and mixtures thereof; and
a metal alloy coating on said surface of said metal substrate, said coating being formed by wire-arc spraying said metal alloy onto said surface, said coating having an outer layer of an electrically insulating layer;
wherein an ECP of said structural component having said electrically insulating layer is less than about −0.23 V_{SHE}.

24. The component of claim 23, wherein said substrate comprises an alloy selected from the group consisting of iron-base, nickel-based, and cobalt-based alloy.

25. The component of claim 23, wherein said metal alloy comprises aluminum, scandium, yttrium, lanthanum, titanium, zirconium, hafnium, vanadium, niobium, tantalum, cerium, and alloys thereof.

26. The component of claim 23, wherein said electrically insulating layer comprises a material selected from the group consisting of oxide, nitride, carbide, boride, and mixtures thereof.

27. The component of claim 23, wherein said electrically insulating layer comprises zirconia.

28. A water-cooled nuclear reactor comprising metal components which are susceptible to stress corrosion cracking during reactor operation and which have been treated to mitigate said stress corrosion cracking, each of said components comprising:
a metal substrate having a surface which has a corrosion potential and is susceptible to stress corrosion cracking in water having a concentration of a dissolved oxidizing species greater than about 200 ppb, said oxidizing species being selected from the group consisting of oxygen, hydrogen peroxide, and mixtures thereof; and
a metal alloy coating on said surface of said metal substrate, said coating being formed by wire-arc spraying said metal alloy onto said surface, said coating having an outer layer of an electrically insulating layer;
wherein an ECP of said structural component having said electrically insulating layer is less than about −0.23 V_{SHE}.
